(19) United States
(12) Patent Application Publication
(10) Pub. No.: US 2022/0414157 A1
(43) Pub. Date: Dec. 29, 2022

(54) APPARATUS AND METHOD FOR MAINTAINING A MACHINE LEARNING MODEL REPOSITORY

(71) Applicant: Graft, Inc., San Francisco, CA (US)

(72) Inventors: Adam OLINER, San Francisco, CA (US); Maria KAZANDJIEVA, Menlo Park, CA (US); Eric SCHKUFZA, Oakland, CA (US); Mher HAKOBYAN, Mountain View, CA (US); Irina CALCIU, Palo Alto, CA (US); Brian CALVERT, San Francisco, CA (US); Daniel WOOLRIDGE, Los Angeles, CA (US); Deven NAVANI, San Jose, CA (US)

(21) Appl. No.: 17/853,673

(22) Filed: Jun. 29, 2022

Related U.S. Application Data
(63) Continuation-in-part of application No. 17/488,043, filed on Sep. 28, 2021.
(60) Provisional application No. 63/216,431, filed on Jun. 29, 2021.

(51) Int. Cl. G06F 16/901; G06F 16/21; G06F 16/28

(52) U.S. Cl. CPC G06F 16/9024; G06F 16/219; G06F 16/289; G06N 20/00

(57) ABSTRACT

A non-transitory computer readable storage medium has instructions executed by a processor to maintain a repository of machine learning directed acyclic graphs. Each machine learning directed acyclic graph has machine learning artifacts as nodes and machine learning executors as edges joining machine learning artifacts. Each machine learning artifact has typed data that has associated conflict rules maintained by the repository. Each machine learning executor specifies executable code that executes a machine learning artifact as an input and produces a new machine learning artifact as an output. A request about an object in the repository is received. A response with information about the object is supplied.

### CROSS-REFERENCE TO RELATED APPLICATION

This application is a continuation-in-part of U.S. Ser. No. 17/488,043, filed Sep. 28, 2021, which claims priority to U.S. Provisional Patent Application Ser. No. 63/216,431, filed Jun. 29, 2021, the contents of each application are incorporated herein by reference.

### FIELD OF THE INVENTION

This invention relates generally to the processing of unstructured data. More particularly, this invention is related to techniques for maintaining a model repository of machine learn models used to process unstructured data.

### BACKGROUND OF THE INVENTION

Most of the world's data (80-90%) is Natural Data™: images, video, audio, text, and graphs. While often called unstructured data, most of these data types are intrinsically structured. In fact, the state-of-the-art method for working with such data is to use a large, self-supervised trunk model—a deep neural network that has learned this intrinsic structure—to compute embeddings—a dense numeric vector—for the natural data and use those as the representation for downstream tasks, in place of the Natural Data.

Unlike structured data, where rules, heuristics, or simple machine learning models are often sufficient, extracting value from Natural Data requires deep learning. However, this approach remains out of reach for almost every business. There are several reasons for this. First, hiring machine learning (ML) and data engineering talent is difficult and expensive. Second, even if a company manages to hire such engineers, devoting them to building, managing, and maintaining the required infrastructure is expensive and time-consuming. Third, unless an effort is made to optimize, the infrastructure costs may be prohibitive. Fourth, most companies do not have sufficient data to train these models from scratch but do have plenty of data to train good enrichments.

If you imagine the spectrum of data-value extraction, with 0 being “doing nothing” and 1 being “we've done everything,” then the goal of the disclosed technology is to make going from 0 to 0.8 incredibly easy and going from 0.8 to 1 possible.

The objective of the disclosed technology is for any enterprise in possession of Natural Data—even without ML/data talent or infrastructure—to get value out of that data. An average engineer should be able to use the disclosed techniques to deploy production use cases leveraging Natural Data; an average SQL user should be able to execute analytical queries on Natural Data, alongside structured data.

### SUMMARY OF THE INVENTION

A non-transitory computer readable storage medium has instructions executed by a processor to maintain a repository of machine learning directed acyclic graphs. Each machine learning directed acyclic graph has machine learning artifacts as nodes and machine learning executors as edges joining machine learning artifacts. Each machine learning artifact has typed data that has associated conflict rules maintained by the repository. Each machine learning executor specifies executable code that executes a machine learning artifact as an input and produces a new machine learning artifact as an output. A request about an object in the repository is received. A response with information about the object is supplied.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing to form an entity database in accordance with an embodiment of the invention.

FIG. 3 illustrates processing to form embeddings in accordance with an embodiment of the invention.

FIG. 4 illustrates query processing performed in accordance with an embodiment of the invention.

FIG. 5 illustrates processing operations and resulting artifacts formed in accordance with an embodiment of the invention.

FIG. 6 illustrates an acyclic graph of executors and artifacts formed in accordance with an embodiment of the invention.

FIG. 7 illustrates a search of artifacts in accordance with an embodiment of the invention.

FIG. 8 illustrates a search of executors in accordance with an embodiment of the invention.

FIG. 9 illustrates a search of artifacts in accordance with an embodiment of the invention.

FIG. 10 illustrates searches performed in accordance with embodiments of the invention.

Like reference numerals refer to corresponding parts throughout the several views of the drawings.

### DETAILED DESCRIPTION OF THE INVENTION

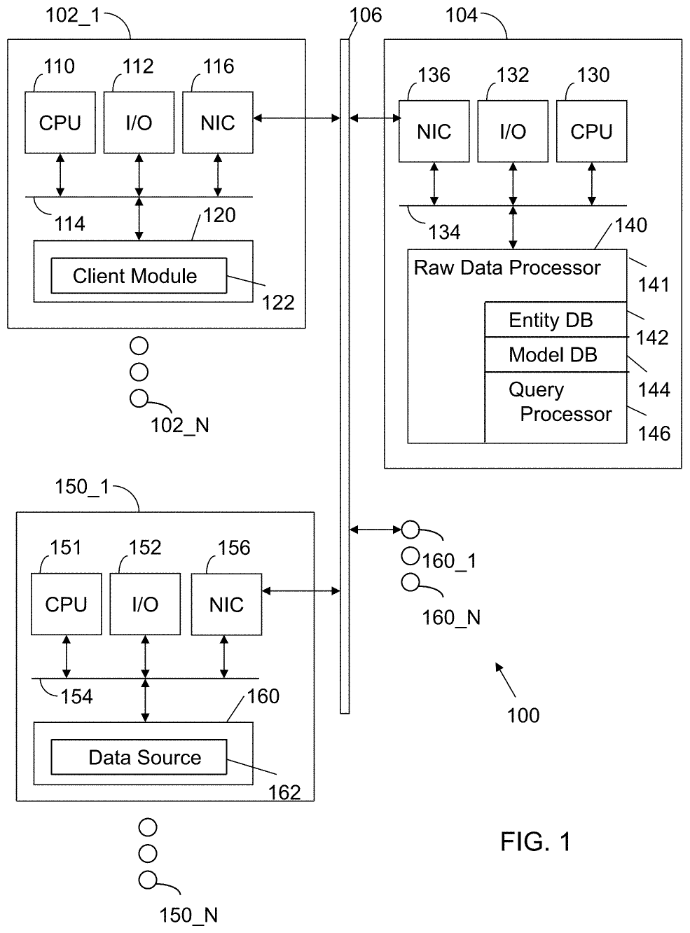

FIG. 1 illustrates a system 100 configured in accordance with an embodiment of the invention. The system 100 includes a set of client devices 102_1 through 102_N that communicate with a server 104 via a network 106, which may be any combination of wired and wireless networks. Each client device includes a processor (e.g., central processing unit) 110 and input/output devices 112 connected via a bus 114. The input/output devices 112 may include a keyboard, mouse, touch display and the like. A network interface circuit 116 is also connected to the bus 114. The network interface circuit 116 provides connectivity to network 106. A memory 120 is also connected to the bus 114. The memory 120 stores instructions executed by processor 110. The memory 120 may store a client module 122, which is an application that allows a user to communicate with server 104 and data sources 150_1 through 150_N. At the direction of the client module 122, the server 104 collects, stores, manages, analyzes, evaluates, indexes, monitors, learns from, visualizes, and transmits information to the client module 122 based upon data collected from unstructured data in images, video, audio, text, and graphs originally resident on data sources 150_1 through 150_N.

Server 104 includes a processor 130, input/output devices 132, a bus 134 and a network interface circuit 136. A memory 140 is connected to the bus 134. The memory 140 stores a raw data processor 141 with instructions executed by processor 136 to implement the operations disclosed herein. In one embodiment, the raw data processor 141 includes an entity database 142, a model database 144 and a query processor 146, which are described in detail below.

System 100 also includes data source machines 150_1 through 150_N. Each data source machine includes a processor 151, input/output devices 152, a bus 154 and a network interface circuit 156. A memory 160 is connected to bus 154. The memory stores a data source 162 with unstructured data.

The entity database 142 provides persistent storage for entities, labels, enrichment predictions, and entity metadata such as when an enrichment prediction was last made. The model database 144 provides persistent storage for trunks, combinators, enrichments, and metadata such as which user owns which model, when a model was last trained, etc.). The query processor 146 is a runtime process that enforces consistency between the entity and model databases, and provides UI access to both via a network connection. It also supports queries against entities, embeddings, machine learning embedding models and enrichment models, as detailed below. Each of these components may be implemented as one or more services.

The following terms are used in this disclosure:
Raw Data (also called Natural Data): Unstructured data, such as images, video, audio, text, and graphs in a native (non-augmented) form at the time of system ingestion.
Data Source: A user-specified mechanism for providing data to be processed. Examples include SQL tables, JSON or CSV files, S3 buckets and the like. FIG. 1 shows data sources 150_1 through 150_N.
Connector: A persistent service which pulls new data from a specified Data Source at regular intervals.
Entity: a time-varying aggregation of one or more pieces of data. For example, a user might define a “Product” entity that describes a commercial product to be all the images and videos associated with the product, a text description, user reviews, and some tabular values like price. As images or reviews are added or modified, the representation of that entity within the system also changes.
Primitive Entity: An entity defined in terms of a single piece of Raw Data. For example, an image or a single product review.
Higher Order Entity: An entity which is defined by combining multiple entities together. For example, the previously mentioned Product entity comprises image entities as well as text entities.
Embedding Model: A machine learning model that produces an embedding. This can be either a trunk model or combinator. Embedding models are applied to raw data or other embeddings to generate numeric vectors that represent the entity.
Trunk Model: A machine learning model that has been trained in a self-supervised manner to learn the internal structure of raw data. A trunk model takes raw data or as input and outputs an embedding, which is a numeric vector.
Combinator: A machine learned model or a process for combining the embeddings from multiple models into a single embedding. This is the mechanism through which the representations of multiple entities can be put together to form the representation of a higher order entity.
Embedding Index: A data structure which supports fast lookup of embeddings and k nearest neighbor searches (e.g., given an embedding, find the k closest embeddings in the index).
Enrichment: Refers either to a property inferred from an embedding or the model that performed that inference. For example, text could be enriched by a sentiment score.

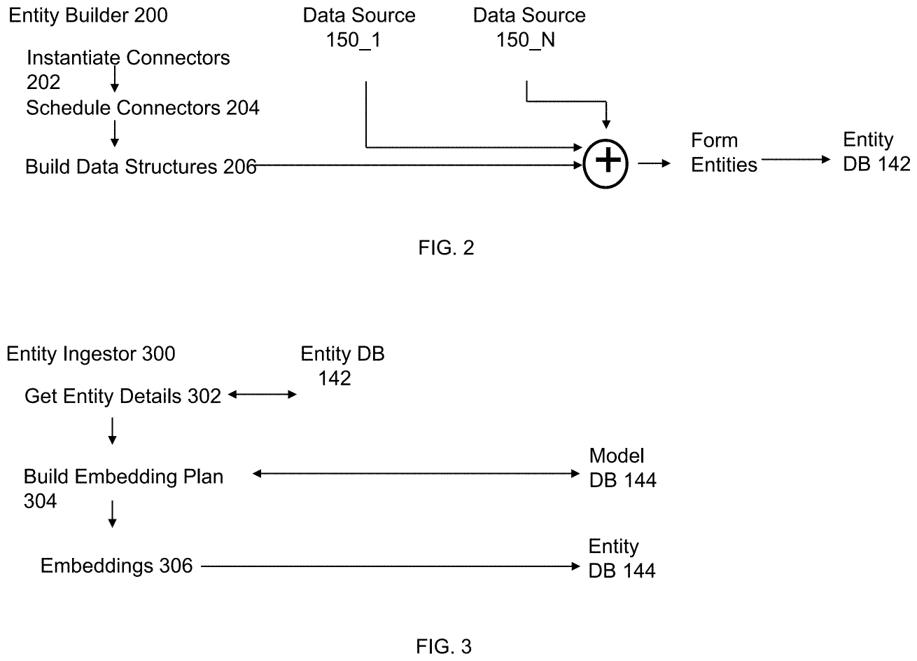

FIG. 2 illustrates the process to form the entity database 142. The raw data processor 141 includes an entity builder 200 with instructions executed by processor 130. The entity builder 200 instantiates connectors 202. That is, the user at client machine 102_1 logs into the raw data processor 141. If this is the first time, a unique username is created for the user. This information, along with metadata for the user account is stored in memory 140. A connection manager allocates storage space for connectors and schedules the times that the connectors are operative 204. The Entity Builder 200 allocates storage space for entities in the Entities database 142.

The entity builder 200 then builds data structures 206. In particular, the user clones or forks a model from a default user or another user who provides public models, such as in data sources 150_1 and 150_N. This makes these models available for use by the user. Storage for these models is allocated in a Model Database 144. Cloning and forking have different semantics (see below). A cloned model does not track the changes made by the user the model was cloned from. A forked model does. We note that when cloning or forking a model, it is not necessary to actually copy any bits. It only becomes necessary to do so for a forked model when a change is made to the model.

The user defines one or more connectors which point to their data (instantiate connectors 202). This data could be multi-modal and reside in very different data stores (e.g., an S3 bucket versus a SQL table). A Data Source is an abstract representation of a pointer to a user's data. Data Sources can contain user login credentials, as well as metadata describing the data (e.g., the separator token for a csv file). Once the user has configured a Data Source, that Data Source can be used to create a Connector.

In the processing of forming the entity database 142, the user forms one or more entities. An entity represents a collection of data from one or more Data Sources (e.g., Data Sources 150_1 and 150_N in FIG. 2). For example, a user might have a collection of photos in S3 and a collection of captions for those photos in a MySQL database. The entity representing a captioned photo would combine data from both of those data sources, as shown with the “+” operation in FIG. 2.

A user defines an entity by selecting Data Sources and describing the primary/foreign key relationships that link those data. The primary/foreign key relationships between these data sources implicitly define a table which contains a single row with data from each of its constituent Data Sources for each concrete instance of the entity. These relationships are defined by the build data structures operation 206 performed by the entity builder 200. Consequently, the entity has relational data attributes.

The Entity Builder 200 takes this description and uses it to instantiate Connectors 202 from the appropriate Data Sources (e.g., 150_1 and 150_N). The Entity Builder 200 also uses that description to create a table in the Entity database 142 (an explicit instantiation of the implicit concept described above). Rows in this table will hold all relevant entity data from the user's Data Sources and also system-generated metadata. Once the table has been created, the Connectors are handed off to a Connection Manager which schedules connectors 204 to periodically wake up. Once awake, the Connectors pick up changes or additions to the user's data.

The process of building data structures 206 involves the user defining one or more embeddings for each of their entities. This involves choosing a pretrained trunk model from the user's Model Database 144 or having the system select a model for them.

After the user or system selects a model, an Entity Ingestor 300 is invoked. The raw data processor 141 includes an Entity Ingestor 300 with instructions executed by processor 130. As shown in FIG. 3, the Entity Ingestor 130 gets entity details 302 from the entity database 142. In particular, the Entity Ingestor 130 is used to extract rows from the user's tables in the user's Entity Database 142. Those rows and the model choice are then passed to an Embedding Service, which builds an embedding plan 304 with reference to the model database 144. The Embedding Service uses a cluster of compute nodes (e.g., 160_1 through 160_N in FIG. 1) which pass the values from each row to the model and produce an embedding. The embeddings are then inserted into an Index Store associated with the Entity Database 144, and an opaque identifier is returned to the Entity Ingestor 300. The Entity Ingestor 300 then stores that identifier, along with metadata such as when the embedding was last computed in the Entity Database 142.

The user can optionally enable continuous pre-training for trunk models. This uses the data in the Entity Database 142 as inputs to an unsupervised training procedure. The flow for this process is identical to that of enrichment training. Supervised pre-training may also be utilized. For example, the trunk model may be updated with the aim of improving performance on one or more specific tasks.

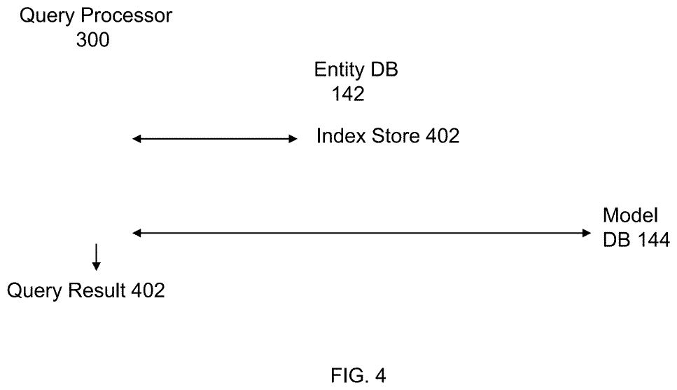

The user may at any point query the contents of the tables that they own in the Entity Database 142. This is done using a standard SQL client and standard SQL commands. The disclosed system provides SQL extensions for transforming the opaque identifier produced by the Embedding Service into the value it points to in the Index Store. These SQL extensions simply perform a query against the Index Store. FIG. 4 illustrates query processor 146 accessing Index Store 402 and the model database 144 to produce a query result 402.

The disclosed technology uses SQL extensions that allow the user to perform similarity queries. These are implemented using k-nearest-neighbor search. A SQL query which asks whether two entities are similar would be transformed into one which gets the opaque embedding identifier for those entities from the Entity Database 142 and then submits them to the Index Store 402. The Index Store 402 uses an implementation of K-nearest-neighbor search to determine whether the embeddings are within K neighbors of each other.

The user defines combinators which generate higher order entities from entities created using trunk models (e.g., an entity which represents a social media user's post history might be defined in terms of entities which define individual posts).

Once the user has defined a combinator, a new table is created in the Entity Database 142 (in the same fashion as described under Defining Entities above), and the Entity Ingestor 300 retrieves the entities from the Entity Database 142 which will be used to generate the higher order entity. The Entity Ingestor 300 extracts the embeddings for those entities (in the same fashion as described under Retrieving Embeddings above), computes a function over them (e.g., averaging the embeddings, concatenating them, or some other function that makes the most semantic sense for the higher order entity) and the new data is inserted into the Entity Database 142.

The user may attach labels to entities. This can be done via standard SQL syntax, as described below or through the web UI defining a data source for the labels. Disclosed below are SQL extensions for querying the set of entities for which label data would be most useful from the perspective of training enrichment models.

The user may define one or more enrichment models. An enrichment model is a machine learning model (e.g., multi-layer perceptron, boosted decision tree, etc.) which maps from entity embeddings to known values (such as semantic labels, or a continuously-valued target variable). Thus, an enrichment model predicts a property of an entity based upon associated labels.

Once a model has been defined it must be trained. This is orchestrated via a scheduler. Periodically, the scheduler activates a Fine Tuning Service. The service gets the enrichment model which must be trained from the Model Database 144. It then passes that model along with embeddings and labels it extracts from the Index Store 402 and Entity Database 142 to a Fine Tuning cluster (e.g., 160_1 through 160_N in FIG. 1). The compute nodes on the Fine Tuning cluster do the actual work of training the model. When they have run to completion, the Fine Tuning Service updates the persistent copy of the enrichment model stored in the Model Database 144.

Whenever an enrichment model is created, the raw data processor 141 also registers a prediction plan with a Prediction Scheduler. The prediction scheduler is run periodically or when new data or embeddings are available. It extracts an enrichment model from the Model Database 144 and passes it along with embeddings it has extracted from the Entity Database 142 to a Prediction cluster (e.g., 160_1 through 160_N in FIG. 1). The nodes in the Prediction cluster do the work of running inference on the models to produce a prediction. That prediction is then stored in the same row of the Entity Database 142 as the entity where the embedding used to generate the prediction is stored. Users may use standard SQL syntax to query predictions from the Entity Database 142.

Alerts based on predictions can be defined using standard SQL syntax. The user simply defines triggers based on the conditions they wish to track. Whenever an embedding or prediction which meets these conditions is inserted or updated in the Entity Database 142, the alert will fire.

SQL is typically used with relational (tabular) data. In such data, each column represents a type of value with some semantics. For example, a Name column would contain text representing a user's first name, middle initial, and last name. To work with unstructured data, specifically Raw Data augmented with embeddings, we require a few necessary SQL extensions, mostly related to administration, entities, similarity, and time. The SQL extensions and SQL processing are described in commonly owned, co-pending patent application Ser. No. 17/488,043, which was previously incorporated by reference. Entity processing is described in commonly owned, co-pending patent application Ser. No. 17/678,942. Connectors are described in commonly owned, co-pending patent application Ser. No. 17/735,994. Attention is now directed toward elaborating on the previously described model database 144.

In contrast to more traditional software modules, ML models require specialized infrastructure components to manage their lifecycle. One of the main specialized components is a model repository or model database 144. Disclosed is a novel design for a model repository. First, there is a discussion of what a model repository is. Next, there is an explanation of the challenges faced when building a model repository. Finally, there is an explanation of the model repository.

A model repository, sometimes called a model registry, is a repository used to store and version trained machine learning models. Model repositories facilitate shared development between scientists (e.g., coordinating work when two scientists are training a model simultaneously, or when one is training a model and the other is performing experiments with it). In this sense, model repositories serve a similar role in a machine-learning development life cycle (MLDLC) to software version control systems (VCS)—in a more standard software development life cycle (SDLC). Concrete examples of shared development include guaranteeing that a scientist has the most recent set of changes made to a model by their colleagues or determining a sound method for combining edits when two scientists have made different changes to the same part of a model.

Beyond storing the models themselves, model repositories often include metadata associated with each ML model. The primary goal of this metadata is to facilitate a full understanding of the lineage/provenance for any given ML model; this metadata is commonly used for model reproducibility (i.e., can we understand how to reproduce a given ML model “from scratch”?) as well as the experimentation part of model development workflows (e.g., “what training algorithm configurations have I already tried and what were their performance metrics?”). In a VCS, these would take the form of comments and experiment logs explaining the relationship between code changes and bugs/performance effects. In a model repository, metadata instead includes things such as hyperparameters used to configure model training algorithms as well as statistical quality metrics for the model's performance on some reference dataset.

To contextualize the challenges of building a model repository, attention is directed to the role of a standard VCS in a traditional SDLC. A SDLC has the following steps:

1. Analysis and definition of requirements for the solution

2. Designing the (software) solution

3. Building the solution

4. Testing the solution

5. Deployment and maintenance of the solution

A standard VCS supports these steps. For example, for the second step (designing the solution) developers often need access to as much system context as possible, including historical system context. A standard VCS facilitates this by storing all versions of relevant code modules (along with features for searching among these stored code modules) as well as supporting context for each version of a code module. In addition to the computer-facing components (e.g., the actual code), the historical context usually includes human-language descriptions of code changes such as the context for why the change was made and/or how it was tested/validated.

To support the fourth and fifth steps (testing, deployment, and maintenance of the solution), standard VCSs commonly integrate with CI/CD systems. In these integrations, a VCS provides a foundational source of truth for what version of code is being tested/deployed/monitored. Beyond tracking the solution code itself, VCSs are often also used as the source of truth for specifications on the tests, deployment and monitoring workflows. A standard VCS can thus be viewed as the main source of truth for how the business's software is meeting requirements (the source code), context for why it was built this way (e.g., historical descriptions, analyses, etc.), how these solutions were tested, how they are deployed, and ultimately how they are monitored and maintained in production.

At a high-level, an MLDLC follows very similar steps as an SDLC. As mentioned above, the relationship between model repositories and the MLDLC is analogous to the relationship between VCSs and the SDLC. As a result, a model repository must meet all of the same requirements as a standard VCS. The key difference that makes this difficult is that ML models can be much more complex “solution artifacts” when compared to source code. The extra complexity primarily stems from the following: (1) although they are produced by code, ML models are also strongly dependent on the data used to train them, and (2) unlike source code, where one can (usually) parse through the execution pathways of a given module, ML models rely on complex chains of non-linear transformations of input data; the human interpretability of an ML model is much lower than source code.

Given this, as a baseline when building a model repository, one faces a set of challenges common to building a VCS. First, it is necessary to track the key “solution artifact” (source code for VCS, models and supporting data for model repositories) and historical context on changes in these artifacts.

Second, it is necessary to provide straightforward integrations with supporting systems including testing infrastructure to validate that a given solution meets the requirements, deployment infrastructure to ensure that a given solution can be “deployed to production”, and monitoring infrastructure to ensure that a deployed solution continues to meet business requirements.

On top of those challenges, one also faces additional challenges entirely novel to ML models. First, it is necessary to track relevant input artifacts used in the MLDLC for a particular ML model. Example artifacts might include the training dataset(s) used to train a given ML model, validation/testing dataset(s) used to ensure the ML model meets requirements, or even other models used as inputs into the model training pipeline.

Second, the performance of ML models is usually driven by statistical algorithms; this has a few notable ramifications: one can often only make statistical claims (instead of absolute claims) about whether an ML model meets business requirements. This drives corollary requirements for supporting systems: testing infrastructure needs to ensure that the input domain for an ML model is sufficiently represented by validation data to validate coverage of requirements. ML model monitoring infrastructure also needs to track the statistical distributions of input data to compare against the distributions of the training/validation datasets (discrepancies between these two are often called “feature drift”). Finally, to mitigate the impact of issues like feature drift, there needs to be a higher-level continuous retraining pipeline that orchestrates the collection and labeling of relevant samples, trains new versions of affected models, and deploys them to production if they pass validation requirements.

Finally, ML models often require specialized hardware for efficient execution. Both development and deployment infrastructure as well as a model repository must have access to this specialized hardware.

The remainder of this disclosure describes a novel design for a model repository that addresses these challenges, the operations it supports, and several applications which it enables.

The model repository or model database 142 of the raw data processor 141 supports general ML artifact storage, where the term artifact includes not only ML models but any arbitrary objects used or produced in the development of ML models such as datasets, model weights, model architecture, and embeddings.

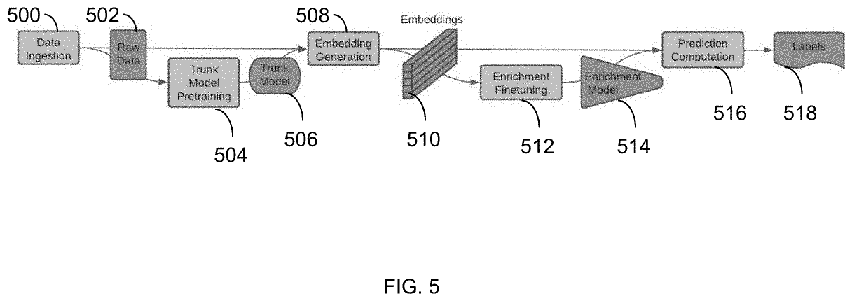

FIG. 5 illustrates a ML execution pipeline with a data ingestion operation 500 which has associated raw data 502. A trunk model pretraining operation 504 produces a trunk model 506. An embedding generation operation 508 produces embeddings 510. An enrichment finetuning operation 512 produces an enrichment model 514. A prediction computation operation 516 produces labels 518.

As part of tracking these artifacts, enough supporting metadata (e.g., training tasks and metrics associated with those tasks), is tracked to enable full reconstruction for any particular artifact instance, including tracking the actual execution used to produce a given artifact (e.g., preprocessing a training dataset, or generating a model from that dataset).

Beyond this general artifact metadata, the disclosed model repository tracks metadata for the ML models which may be useful for end users. This includes distributional information over training datasets (e.g., known biases) which may be useful for explaining the behavior of a trained model. This also includes information related to a model's input (e.g., which parts of its inputs are expected to be text or image data, how that image data is expected to be encoded, etc.) and outputs (e.g., which elements of the embedding it generates correspond to which of its inputs).

At a high level, the disclosed model repository can be thought of as a typed version control system which tracks not only artifacts, but the arbitrary computations that produced them. Traditional VCSs are defined in terms of a single type of artifact: code. They have mechanisms for tracking changes to code, and code-specific strategies for resolving conflicts when two or more users make different changes to code (e.g., if two different users add different lines of code, accept both, but if two users edit the same line of code, ask the owner of the code to choose which they prefer). The disclosed model repository tracks multiple different types of artifacts: models, datasets, etc. and has type-specific strategies for dealing with conflicts. For example, it has different strategies for resolving conflicts when two users edit the same dataset as when two users modify the same hyperparameter.

Because traditional VCSs are defined in terms of code, it is only necessary for them to track different versions of that code (the files that make up a program). They do not need to keep track of how those changes were made (the order in which the programmer modified those files). In contrast, the disclosed model repository tracks the arbitrary code executions (training passes) that produce changes to artifacts. This allows for non-trivial performance optimizations: for example, many model training algorithms are statistically idempotent, where this term signifies that these two executions will produce models where, even if the two models might slightly differ in terms of the exact weight values, they have statistically equivalent performance in terms of performance metrics. If two users execute the same statistically idempotent training code with equivalent inputs, the model repository can be configured to only execute one of the two calls and return its output to both callers. This feature can also be turned off if needed, for example to measure if a particular training algorithm is statistically idempotent in the first place.

Formally, we say that the model repository tracks two types of objects: artifacts and executors. An artifact is a typed piece of data where typed means that the model repository has specific methods (conflict rules) for resolving conflicts between artifacts that are based on their types. To give some example, for changes to model training hyperparameters, there is no semantically sensible way to merge the two changes (similar to a standard VCS when two users modify the same lines of source code) so the repository would solicit human intervention to resolve the two conflicting changes. On the other hand, for a dataset, assuming the dataset has per-row UUIDs (i.e., primary keys), the repository can understand if two distinct changes to a dataset are affecting the same unique rows of that dataset. If not, they can be merged and otherwise the repository could fall back to soliciting human intervention. These types have a semantic relationship between them as well, and the repository uses these relationships to determine whether it should even try to resolve differences—for example, the repository would immediately flag a difference resolution between a hyperparameter and a dataset as nonsensical. There is a focus on three types of artifacts: ML models, datasets, and hyperparameters. However, it should be noted that a model repository could track other types as well, depending on its implementation. In FIG. 5, for example, blocks 502, 506, 510, 514 and 518 are all artifacts.

An executor is a piece of code and an environment in which that code is run which takes one or more artifacts as inputs and produces a new artifact as an output. The model repository uses containers as its implementation of executors, though other implementations are possible as well. Examples of executors include: (1) a container which takes three artifacts: a training dataset, a transformer architecture, and a set of hyperparameters and when run produces a BERT-style model, (2) a container which takes a set of training data, and through some statistical process augments that training set with new examples. In FIG. 5, the blocks 500, 504, 508, 512 and 516 are executors.

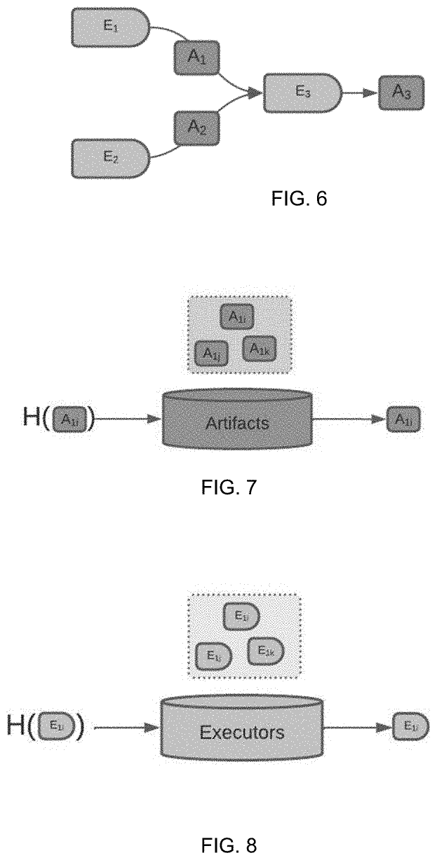

Internally, the model repository maintains a directed acyclic graph, where artifacts are nodes, and executors are multi-edges which join those nodes. This is illustrated in FIG. 6, which shows executors E1 and E2 producing artifacts A1 and A2. Executor E3 then processes the artifacts to produce artifact A3. Each artifact and executor is tagged with a version hash to enable both direct and relational interactions with these artifacts/executors. One example of a direct interaction is retrieval of a particular version of a specific artifact/executor. This is illustrated in FIGS. 7 and 8. FIG. 7 illustrates a repository of artifacts that may be queried, while FIG. 8 illustrates a repository of executors that may be queried. In these figures, the “Artifacts”/“Executors” cylinders represent the repository's stored collections of the respective types of objects. To get a particular version (version i) of a specific Artifact (Al/E1 in this figure), one queries the repository with the unique hash, e.g., H(A1i), of the object in question (where the hash might have been recorded previously or was dynamically retrieved via a separate query).

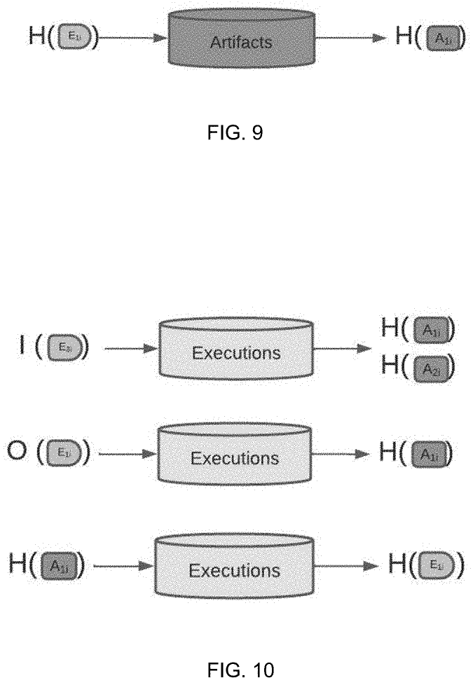

An example of a relational interaction would be a dependency graph query to understand if a particular version of an executor was used to produce any known artifacts. This query is illustrated in the FIG. 9.

A given artifact can only be produced by an execution of a particular executor; thus, the repository also stores metadata describing these individual executions. Beyond providing metadata for reproducibility purposes (for example: querying for metadata on relevant aggregations of infrastructure logs collected during the executor's execution), this metadata, when combined with the other object stores, also provides sufficient relational information to understand the full dependency graph.

Example queries for this are shown in the FIG. 10. In respective order, they represent the following queries:
What were the specific input artifacts I(E₃ᵢ) to the last execution of E₃ᵢ?
What was the specific output artifact O(E₁ᵢ) from the last execution of E₁ᵢh?
What executor was used to produce the specific artifact A₃ᵢ?

A traditional VCS tracks a single type of artifact: code, so implicitly every versioned hash in a VCS answers the question “what was the state of the code at this point in time?”. The disclosed model repository tracks multiple types of artifacts so the relationship between hashes is more complex.

In a traditional VCS any two hashes correspond implicitly to the same object. In the disclosed model repository, whether two hashes refer semantically to the same artifact depends on the set of edges which connect those two artifacts. Types help to resolve this complexity. For example, if the user points to a versioned artifact, the model repository knows its type (e.g., model). Using this information, the repository can answer the question “what was the state of this artifact in the past?” by searching backwards through the edges which lead to this artifact and filtering out the nodes which specifically correspond to models (as opposed to, say, training data).

In other cases, a user might want to track correlations between differently typed artifacts. For example, they might ask “what dataset was used to train this model?” As above, types can be used to resolve queries of this form. If the user points to a model, the disclosed model repository can search backwards through the directed graph of executors which ultimately produced this model and can retrieve all artifacts with type dataset which were provided as inputs to those executors.

In addition to answering questions regarding the state of artifacts at some time in the past, the disclosed model repository also uses type information to track metadata related to artifacts. In contrast to artifacts, which are user editable, this information is functionally determined by artifacts and is treated as read only. For example, the disclosed model repository can take an artifact of type model and return information relating to its architecture (e.g., the number of layers it contains, the connectivity between those layers, the distribution of weights in those layers), or a tuple consisting of artifacts of type model, data, and metric and report the performance of the model on that data with respect to that metric.

In general, any number and type of type-determined metadata productions which are parameterized by artifact types are possible and a function of the implementation. To support arbitrary implementations, the disclosed model repository maintains an internal mapping from tuples of artifacts and their respective types to pieces of code which can be installed by the user. In the case where the user wishes to provide two different types of metadata for tuples of the same type, these metadata implementations can be disambiguated by assigning them unique names.

Metadata is useful both for helping the user to understand the properties of artifacts over time (e.g., changes in the accuracy of a model with respect to a reference dataset over time) and in helping a repository owner to reason about changes made to artifacts by multiple users which are incompatible with one another.

Given an initial set of artifacts, and a collection of executions, it is possible for the disclosed model repository to rematerialize the downstream artifacts defined by those executions. In this sense, one can think of the model repository as a data dependency graph which defines the entire lifecycle of ML artifacts. This is useful both from the perspective of repeatability and verification.

In practice, performing the computations associated with executions may be prohibitively expensive. Training a machine learning model can take millions of epochs that consume terabytes of training data. As a result, the model repository may choose (depending on a user's access patterns) to cache the outputs of an execution so that future queries (e.g., show me the state of a model on this date) can be returned immediately. The specifics of this caching are left up to the implementation. One simple implementation is to use a Last Recently Used (LRU) cache in which artifacts have their time to live refreshed whenever they are accessed.

The computation of some metadata (e.g., the performance of a model on a reference data set) may suffer from the same performance obstacles described above. In some sense, one can think of metadata as the output of an execution which is implicitly defined by the model repository. In this sense, the solution is the same: metadata is cached according to an implementation-specific policy to reduce the overhead of handling queries which might otherwise require an arbitrarily large amount of computation.

The disclosed model repository supports many of the same core operations provided by a VCS. The key difference is that these operations are reframed in the context of providing access to typed artifacts as opposed to just source code. The user requests versioned artifacts from the repository and describes the changes they wish to persist by providing the repository with an execution. Key to this process is that the model repository has different strategies for tracking changes to and resolving conflicts between changes to artifacts of different types.

Given a reference (as in a VCS, a unique hash) to an artifact, the model repository provides the user with a copy of that artifact. As described above, that copy may either be produced on demand by re-evaluating the graph of executions that define the artifact at a particular state in time, or it may be returned directly from a cache of materialized artifacts.

Cloning and forking have the same semantics as in a VCS. Both operations result in a copy of the artifact on the user's machine. But whereas a cloned artifact is logically disconnected from the original copy in the model repository, a forked artifact preserves a logical connection. Changes to an artifact in the model repository can be retrieved by users who have forked a copy of that artifact whereas this is not possible for users who have cloned a copy. Similarly, changes to forked artifacts made via pull requests (see below) can be propagated back to the repository and can be retrieved at a later time by users who have forked a copy of that artifact.

Intuitively, cloning a model is like taking a snapshot which, whereas forking a model is like creating a pointer to a model which can be used to retrieve new snapshots whenever that model changes.

Regardless of whether a user has cloned or forked an artifact, any changes that are made to that local copy can be committed (i.e., those local changes can be saved). Committing changes to an artifact allows a user to periodically checkpoint their work in their local environment and rollback changes that they are unhappy with to a last known good commit. For example, the user may decide they are unhappy with new examples which they have added to a training dataset and want to roll them back, or decide they are happy with changes they have made to a learning parameter and wish to preserve those changes.

After the user has made one or more commits to their copy of the artifact, they can then push those changes back to the model repository. The user does this by providing references to one or more cloned/forked artifacts and providing an execution over those artifacts. The execution is saved to the repository and an artifact which captures the changes implied by that execution can now be recovered regardless of what happens in the user's environment (as in a VCS, the model repository keeps track of these artifacts by assigning them unique hashes).

As described above, the computation associated with an execution may be arbitrarily expensive. In addition to providing an execution as part of a push operation, a model repository may also ask the user to provide the artifact which corresponds to performing that execution. Depending on the implementation, the model repository may choose to take that artifact on faith, or to evaluate the execution offline when the repository is in an idle state to verify that the artifact is a faithful representation of its execution.

A model repository which pursues either of these strategies could then provide speculative responses to clone/fork requests. Artifacts whose executions are unverified could be tagged as such and help the user to understand that their work might potentially need to be repeated if verification fails at some point in the future.

After pushing one or more change sets to a forked artifact, the user can submit a pull request. A pull request is a way of asking the artifact owner to accept the changes made by the user. Intuitively, this is a mechanism for a user to do work on behalf of the artifact owner, and for the artifact owner to verify that work before accepting it into the model repository so that it can be persisted and propagated to other users who have forked the artifact.

In supporting pull requests, the model repository must address the same core implementation issue as a VCS: identifying and resolving incompatible changes made by two or more developers to the same artifact at the same time.

As a motivating example, consider the case where two users have forked the same model, and have pushed changes to their copies of the model. Both have performed additional training passes, but one has run for more iterations than the other (i.e., they have defined different executions over the same input artifact). They now have separate copies of the original artifact which disagree on model weights. A second more complicated example would be the following: one user has performed additional training which has resulted in a different set of weights whereas the second user has added new examples to the training data associated with the model. In both cases, the changes define a new set of model weights. However, the mechanism by which they produce those weights differ. Regardless, the changes are potentially incompatible with one another; both users are attempting to push a version of the model with different weights. This conflict must first be identified and then resolved.

The disclosed model repository uses type information to make the process of identifying and resolving conflicts tractable. A priori, it knows that merge conflicts between objects of different types are unresolvable and should be rejected outright. For example, if two users fork a model, and one attempts to push an execution which trains the model, while the other attempts to push an execution which ignores the model and returns a dataset, the change cannot be resolved automatically. The user must resolve the conflict manually.

In contrast, merge conflicts between objects of the same type can be resolved in a domain-specific fashion. We provide several examples below and note that the types that a model repository may choose to support and the specific strategies it uses for identifying and resolving conflicts are an implementation-specific decision.

Models are defined in terms of their architecture and their weights. Two models which disagree on architecture are incompatible and the conflict must be resolved manually. Assuming the models have the same architecture, conflicts can then be identified by scanning the weights in both copies in lock step and comparing them one at a time.

Resolving conflicts is also straightforward: the weights which disagree are simply averaged. While other merge strategies are possible, averaging performs well in practice and is motivated by analogy to the well-understood process of data parallel training. In data parallel training, multiple copies of a model are instantiated on multiple machines, each trained with different inputs, and after the models are updated, their weights are averaged together. In the language of the model repository, the original model is forked N ways, each of the N copies are trained, N pull requests are submitted, and the repository automatically resolves the resulting merge conflicts.

Datasets can be represented as ordered lists of tuples. Two datasets which contain tuples of different arity are incompatible and the conflict must be resolved manually. Conflicts between datasets with identical arity tuples can be identified by checking for additions, deletions, and modifications of tuples. A conflict occurs when two users provide change sets that disagree on those three operations. These conflicts can be resolved using the same strategy used by a traditional VCS: both sets are accepted, and when both users attempt to modify the same tuple, or where one user attempts to add/delete a tuple and another user attempts to delete/add it, the conflict must be resolved manually by the user.

In some cases, two users may fork the same artifact (e.g., a model) and attempt to push two different executors that result in a spurious merge conflict (e.g., they both performed the same number of training iterations using the same training algorithm, but non-determinisms in the algorithm resulted in updated weights that are not exactly the same).

Specific implementations of a model repository may choose to identify spurious conflicts of this form and choose to resolve the merge conflict by arbitrarily choosing one of the resulting artifacts to serve as the ground truth in the repository. In similar fashion, an implementation of a model repository might be able to save storage space by identifying places where the sequence of executors that resulted in two different model artifacts differ only in statistically insignificant non-determinisms. By identifying these symmetries, the repository can choose to discard all but one of the models from permanent or cached storage.

A user who has retrieved a copy of an artifact may periodically want to check for changes that have been made to the original artifact via pull requests. Performing a pull request retrieves the latest copy of the artifact and attempts to resolve that copy against the one that the user is working with. As the user may have made changes to their local copy that are incompatible with the newest copy of the artifact, the same issues described above can arise. As above, conflicts can be resolved in a type-dependent fashion.

While this process can be performed automatically, the user may still wish to know the extent to which the upstream artifact and their copy differed (e.g., how significant were the merge conflicts and how much work needed to be done to resolve them). In a VCS this information typically takes the form of the number of lines of code that were added, deleted, and modified on a file-by-file basis. In the disclosed model repository, this purpose is served with metadata. To use model artifacts as an example, these could include: the number of weights changed per layer, the aggregate drift in the distribution of the values of those weights, the performance of the model before and after the merge conflicts were resolved on training tasks associated with the model in the model repository, etc.

Attention is now directed to applications which are supported by the disclosed model repository. These are applications that would ordinarily require a large implementation, but which fit naturally into the disclosed model repository's architecture.

In addition to providing persistence for models, the disclosed model repository is well suited to answering questions about models. As part of its implementation, the model repository provides all of the necessary infrastructure for training and updating models. This means that it can also be used to evaluate the behavior of models on previously unseen datasets.

One question the user may wish to ask is: given a dataset, what is the best trunk model to use for embedding that data? The disclosed model repository can answer this question automatically by performing the following operations: (1) first select all models whose metadata indicates that they are compatible with the data (e.g., they are the same modality and have the appropriate number of input neurons, (2) embed some subset of that data using each of the models (3) observe the distribution of embeddings and evaluate them with respect to some statistical criteria (e.g., maximum variance in embeddings, minimum variance in embeddings that form a cluster, etc.) and return the tuple that corresponds to the model that maximizes this criteria.

Related to this question is the question of how good a fit a specific model is to a previously unseen dataset. The process is the same as above, the model is used to embed some subset of that data, and statistical criteria are evaluated. Those criteria or some natural language distillation of those criteria are then reported to the user. For example, the repository might either report “variance among embeddings in the same cluster=0.123” or “This model does a good job of clustering data, but the data within clusters is not too spread out. This means it will do a good job of separating different types of data, but have a hard time telling items of the same type apart”.

Some users may be less concerned with training their own models and may simply want to stay up to date with changes made by another user. An example of this might be an organization that is split into two parts: (1) the scientists who are responsible for training models and (2) the application engineers who are responsible for using those models to solve problems.

The disclosed model repository supports a workflow in which application engineers can be sure that they are always working with the most up to date version of a model. The engineers simply (1) fork a copy of the model, and then (2) write a cron job to poll the repository for updates. Whenever an update is available, the cron job pulls the changes and the engineers are provided with the most up to date version of the model.

Some scientists may be interested in working with datasets in which the input data (which represents entities) is continuously changing. In this case, in addition to continuously recomputing the embeddings for those entities, they may also wish to continuously train their model on that data as it changes. By storing those changes to the model repository at regular intervals, they guarantee that the most up to date version of the model is always available to downstream users.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A non-transitory computer readable storage medium with instructions executed by a processor to:
maintain a repository of machine learning directed acyclic graphs, where each machine learning directed acyclic graph has machine learning artifacts as nodes and machine learning executors as edges joining machine learning artifacts, where each machine learning artifact has typed data that has associated conflict rules maintained by the repository and where each machine learning executor specifies executable code that executes one or more machine learning artifacts as an input and produces a new machine learning artifact as an output;
receive a request about an object in the repository; and
supply from the repository a response with information about the object.

2. The non-transitory computer readable storage medium of claim 1 wherein the machine learning artifacts and machine learning executors are tagged with version hashes.

3. The non-transitory computer readable storage medium of claim 2 wherein the machine learning directed acyclic graphs and version hashes are used to characterize direct and relational interactions between the machine learning artifacts and the machine learning executors.

4. The non-transitory computer readable storage medium of claim 3 wherein the request is a reference to a machine learning model and the repository executes code on the processor to search a machine learning directed acyclic graph associated with the machine learning model to specify all machine learning artifacts and all machine learning executors associated with the machine learning model.

5. The non-transitory computer readable storage medium of claim 2 wherein the version hashes are used to provide copies of repository objects.

6. The non-transitory computer readable storage medium of claim 5 wherein the repository objects are cloned objects.

7. The non-transitory computer readable storage medium of claim 5 wherein the repository objects are forked objects that preserve logical links to parents of forked objects.

8. The non-transitory computer readable storage medium of claim 7 wherein a forked object has a pull request that asks an object owner to accept changes to the forked object.

9. The non-transitory computer readable storage medium of claim 1 wherein the request includes a dataset and a request for the best trunk model to use for embedding the dataset and the repository executes code on the processor to select trunk models with metadata compatible with the dataset, embed data for the trunk models, define a distribution of embeddings, evaluate the distribution of embeddings with statistical criteria, designate a selected model based upon favorable statistical criteria, and return the selected model as the response.

10. The non-transitory computer readable storage medium of claim 1 wherein machine learning executors specify environments to execute the machine learning executors.

11. The non-transitory computer readable storage medium of claim 1 wherein the conflict rules of the typed data are used to combine different changes to a selected machine learning model.

12. The non-transitory computer readable storage medium of claim 1 wherein the machine learning artifacts include machine learning models.

13. The non-transitory computer readable storage medium of claim 1 wherein the machine learning artifacts include datasets.

14. The non-transitory computer readable storage medium of claim 1 wherein the machine learning artifacts include model weights.

15. The non-transitory computer readable storage medium of claim 1 wherein the machine learning artifacts include model architectures.

16. The non-transitory computer readable storage medium of claim 1 wherein the machine learning artifacts include embeddings.

17. The non-transitory computer readable storage medium of claim 1 wherein the machine learning artifacts include arbitrary objects used or produced in the development of machine learning models.

18. The non-transitory computer readable storage medium of claim 1 wherein the repository includes metadata and executable code to compare metadata to facilitate a full understanding of the lineage of machine learning models.

19. The non-transitory computer readable storage medium of claim 1 wherein the repository includes metadata for hyperparameters used to configure machine learning model training algorithms.

20. The non-transitory computer readable storage medium of claim 1 wherein the repository includes metadata for statistical quality metrics for machine learning model performance for a given dataset.

21. The non-transitory computer readable storage medium of claim 1 wherein the repository includes metadata defining specialized hardware for efficient machine learning model execution.
